(19) United States
(12) Patent Application Publication
(10) Pub. No.: US 2026/0186755 A1
(43) Pub. Date: Jul. 2, 2026

(54) METHOD FOR OPERATING AN INFORMATION TECHNOLOGY SYSTEM, INFORMATION TECHNOLOGY SYSTEM AND VEHICLE

(71) Applicant: MERCEDES-BENZ GROUP AG, Stuttgart (DE)

(72) Inventor: Thorsten WILMER, Sindelfingen (DE)

(21) Appl. No.: 19/130,586

(22) PCT Filed: Oct. 26, 2023
(86) PCT No.: PCT/EP2023/080001

§ 371 Date: May 16, 2025

(30) Foreign Application Priority Data
Nov. 21, 2022 (DE) 10 2022 004 347.5

(51) Int. Cl. G06F 8/41

(52) U.S. Cl. CPC G06F 8/445

(57) ABSTRACT

An information technology system completes at least one task by dividing program code by a compiler in a compiling step into at least two function blocks and arranging the divided code in a data flow graph. The compiler analyzes the data flow graph to determine an execution sequence in which the processor will execute the respective function blocks. The compiler determines the function blocks that can be executed in parallel by the processor when completing the at least one task, the compiler checks, for each group of function blocks that can be executed in parallel, whether at least program code parts of at least two function blocks require the same instruction to be executed by the processor, and the compiler assigns these program code parts in accordance with single instruction, multiple data to the same execution unit of the processor for simultaneous completion.

### BACKGROUND AND SUMMARY OF THE INVENTION

Exemplary embodiments of the invention relate to a method for operating an information technology system, to a corresponding information technology system, and to a vehicle comprising such an information technology system.

Information technology systems such as computers, embedded systems, or similar computing devices undoubtedly play a considerable role in solving a wide variety of everyday problems. One development goal in this regard is to increase the performance of hardware components in tandem with miniaturization. This enables complex tasks to be solved, including in the context of mobile applications.

As digitalization increases, so too does the importance of computing systems in vehicles. Modern vehicles have a wide variety of different control devices, for example for powertrain control, navigation route calculation, or communication between the vehicle and the internet. Computationally powerful hardware components are indispensable here for computing time-critical control signals fast enough in order, for example, to uphold the user experience by processing user input quickly enough and outputting corresponding responses quickly enough, and the like. Furthermore, vehicles only have a limited amount of installation space available for integrating computing components. In addition, the integration of such computing devices should not cause the manufacturing costs of vehicles to increase disproportionately. This makes developing computing systems for the automotive sector particularly challenging. In summary, there is a need to constantly improve the performance and efficiency of computing components.

One well-known approach to speeding up computer-assisted problem-solving is parallelization. Modern processors can have a plurality of execution units, for example computing cores, thereby enabling what is known as multithreading, i.e., the simultaneous completion of different tasks by one and the same processor.

A further possibility for boosting computing efficiency is single instruction, multiple data (SIMD). SIMD enables computing systems to perform the same computing operations simultaneously on multiple data points. By way of example, on a PC, this can reduce the required number of write and read accesses to the RAM and the number of computing operations to be executed by the processor (CPU). Correspondingly, the time taken by a program to solve a task can be reduced. For instance, D. Nuzman et al., “Vapor SIMD: Auto-vectorize once, run everywhere,” International Symposium on Code Generation and Optimization (CGO 2011), 2011, pp. 151-160, doi: 10.1109/CGO.2011.5764683 describes how compilers transform loops in order to code multiple iterations of the same loop in parallel in SIMD instructions.

In addition, WO 2007/113369 A1 discloses a method for generating a program that can be executed in parallel. The method describes compiling a computer program from a source code into a code that can be executed, with a data flow graph being generated from the corresponding source code and this being examined to analyze data dependencies. The thus generated program that can be executed is divided into individual packets that are distributed across the individual execution units of the processor of the used computing device. In the process, an execution sequence is determined as late as possible, so that the computing architecture of the computing device currently being used can be taken into account. This enables the load to be distributed particularly efficiently across the individual execution units of processors, independently of a wide variety of computing devices that can be used to execute the program. Here, as well, increasing computing speed is based on distributing individual program parts across multiple execution units of one or multiple processors in order to parallelize program sequences.

Exemplary embodiments of the present invention are directed to an improved method for operating an information technology system which can be used to boost the performance of information technology systems even further.

A method of the type in question for operating an information technology system, wherein in order to complete at least one task, program code which can be used by a processor is divided by a compiler in a compiling step into at least two function blocks and these are arranged in a data flow graph and the compiler analyzes the data flow graph to ascertain an execution sequence in which the processor will execute the respective function blocks, is refined according to the invention such that the compiler ascertains the function blocks that can be executed in parallel by the processor when completing the at least one task, the compiler checks, for each group of function blocks that can be executed in parallel, whether at least program code parts of at least two function blocks require the execution of the same instruction by the processor, and the compiler assigns these program code parts in accordance with single instruction, multiple data to the same execution unit of the processor for simultaneous completion.

By means of the method according to the invention, the degree of parallelization of programs can be increased even further. Thus, not only is it possible to simultaneously complete different programs with one processor having multiple execution units, but one and the same execution unit of the processor is able to simultaneously complete different parts of the same program in one computing cycle.

The simultaneous execution of sub-functions of one and the same task makes it possible to save cycle time in the processor and thus solve the underlying task faster, i.e., complete the corresponding program faster.

The processor can have multiple execution units, for example processor cores. The processor does not necessarily have to have multiple physical execution units. The processor can also be designed to carry out multithreading. The processor may be a central processing unit (CPU), a graphics processor, better known as a graphics processing unit (GPU), or some other dedicated programmable arithmetic unit, for example integrated on a system-on-a-chip (SoC).

In order to ascertain the function blocks that can be executed in parallel, the compiler checks the interdependencies of the individual function blocks in the data flow graph. A function block typically has an input interface and an output interface. The required data is provided to the function block via the input interface and the result generated via the respective function block is provided via the output interface. If a function block requires a certain result from another function block or if the function block transfers its computed result to a further function block, then these function blocks cannot be executed in parallel. If, however, two function blocks do not have any dependencies in terms of their respective input and output data, they can in general be executed in parallel.

One particularly efficient application of the method according to the invention is possible if, in the case of function blocks containing loops, these function blocks or the respective loops have the same depth and particularly preferably the same upper limit.

One advantageous refinement of the method provides that the compiler ascertains the number of instructions to be completed by the processor for each of the function blocks that can be executed in parallel and, for those function blocks containing fewer instructions than the function block with the maximum number of instructions of a respective group, the compiler installs placeholder instructions in the respective function blocks for the respective group of function blocks that can be executed in parallel, so that all function blocks of a respective group contain the same number of instructions. If the function blocks of a group of function blocks that can be executed in parallel contain the same number of instructions to be executed by the processor, a particularly simple and efficient assignment of the program code parts to the same execution unit of the processor in accordance with single instruction, multiple data is possible. “Instructions” in this context means the presence of the same instruction in all function blocks of the group of function blocks that can be executed in parallel. By way of example, this instruction may be the command “add” or “multiply”. If individual program code parts deviate from this instruction or are missing, for example if the instruction “multiply” is used instead of “add” or a command line is missing entirely, then a placeholder instruction should be inserted at the corresponding point in the respective functionality block, in order to be able to assign the program code parts in accordance with single instruction, multiple data.

A further advantageous embodiment of the method according to the invention further provides that if the program code parts contained by the function blocks of a group of function blocks that can be executed in parallel comprise loops:
the compiler ascertains a respective number of iterations of the loops;
the compiler checks whether the loops of the function blocks that contain the program code parts assignable to the same execution unit of the processor in accordance with single instruction, multiple data comprise a different number of iterations; and if this is the case:
the compiler ensures that respective program code parts of the function blocks are completed simultaneously by the same execution unit of the processor in accordance with the lowest number of iterations and that those program code parts of the function blocks with a higher number of iterations are completed sequentially by the processor in accordance with the remaining iterations.

It is possible to carry out the method according to the invention in a particularly efficient and simple manner if the program code parts to be assigned to the same execution unit of the processor in accordance with single instruction, multiple data consist only of one instruction of the same type. However, the corresponding program code parts of the function blocks can also contain loops. If multiple function blocks have a different number of iterations of corresponding loops, only those program code parts can be parallelized in accordance with single instruction, multiple data that involve the same instructions in the function blocks of the group of function blocks that can be executed in parallel, corresponding to the number of iterations of the loop with the lowest number of iterations. In other words, for the program code parts of the function block with the higher number of iterations, there are no longer any corresponding instructions from the remaining function block available for simultaneous distribution to the execution unit of the processor. The corresponding excess is then completed sequentially by the processor.

Preferably, in the case of a multithreading-capable processor, at least two different tasks are completed in parallel on at least two different execution units of the processor. As a result, the degree of parallelization can be increased even further. It is also conceivable in this case that the method according to the invention for assigning the program code parts in accordance with single instruction, multiple data is applied individually for each task on each execution unit of the processor. Therefore, multiple tasks can be completed simultaneously on multiple execution units, with parallelization in accordance with the method according to the invention taking place on each individual execution unit.

According to the invention, an information technology system is designed for executing an above-described method. The information technology system may be a known computing device such as a PC, an embedded system, a SoC, or the like. Particularly in context of embedded systems, the method according to the invention can be used particularly advantageously, since comparatively weak hardware components are installed here, which makes it necessary to use other measures to increase computing efficiency.

Such an information technology system is particularly preferably integrated in a vehicle according to the invention. The vehicle may be any vehicle, such as a passenger car, lorry, van, bus, or the like. The information technology system can be a central onboard computer, a control unit of a vehicle sub-system, or the like. Multiple such information technology systems may also be integrated in the vehicle. As already mentioned in the introduction, there are limits to the integration of powerful computing components in vehicles. By applying the method according to the invention and integrating such an information technology system according to the invention, the computing efficiency and thus performance of the computing devices installed in the vehicle can be increased, thereby making it possible to utilize the available installation space in a space-saving manner and ensuring that the vehicle can be manufactured cost-effectively.

### BRIEF DESCRIPTION OF THE DRAWING FIGURES

Further advantageous embodiments of the method according to the invention for the operation of the information technology system will also become apparent from the exemplary embodiments, which are described in more detail hereinbelow with reference to the figures, in which:

FIG. 1 shows an illustration of a program code divided into individual function blocks as a data flow graph; and

FIG. 2 shows pseudocode of the function blocks C and D shown in FIG. 1 and an assignment of instructions contained by the pseudocode to the same execution unit of a processor in accordance with a method according to the invention.

### DETAILED DESCRIPTION

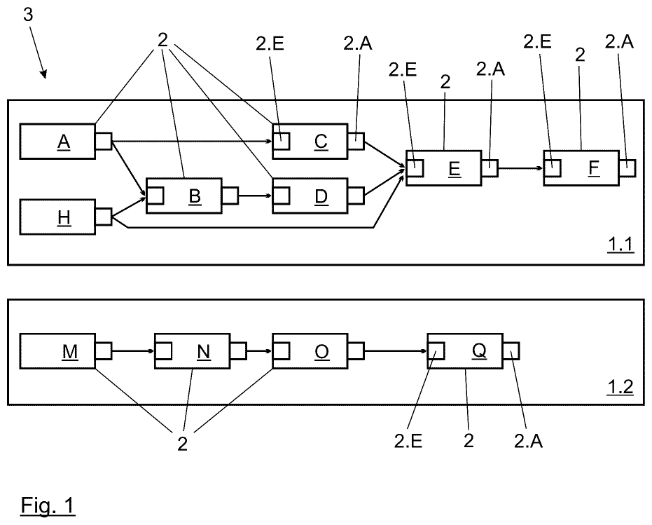

FIG. 1 shows, in an abstracted representation as a data flow graph 3, a program code that is executed on an information technology system for solving one or multiple tasks 1.1, 1.2 and is divided into individual function blocks 2. A function block 2 corresponds in this case to a separately computable sub-problem of the respective task 1.1, 1.2. The processor of the information technology system can be designed to execute multithreading, which enables the parallel completion of multiple tasks 1.1, 1.2, i.e. multiplier execution strands. The execution strands can have the same or a deviating execution frequency. In this case, each task 1.1, 1.2 is assigned to an individual execution unit of the processor, i.e., separate computing cores, for example. This represents a first possibility for the parallelization of programs. For the sake of clarity, only some of the reference objects of the same type are given reference signs in the figures.

The individual function blocks 2 have input interfaces 2.E for reading in input data and output interfaces 2.A for outputting computation results. By taking appropriate data dependencies into account, an execution sequence of the function blocks 2 can be derived. In an information technology system known from the prior art, the individual function blocks 2 of the respective tasks 1.1 and 1.2 are in each case executed sequentially one after another. However, this wastes computing capacity, since in general individual function blocks 2 or program code parts contained by the respective function blocks 2 could also be executed in parallel.

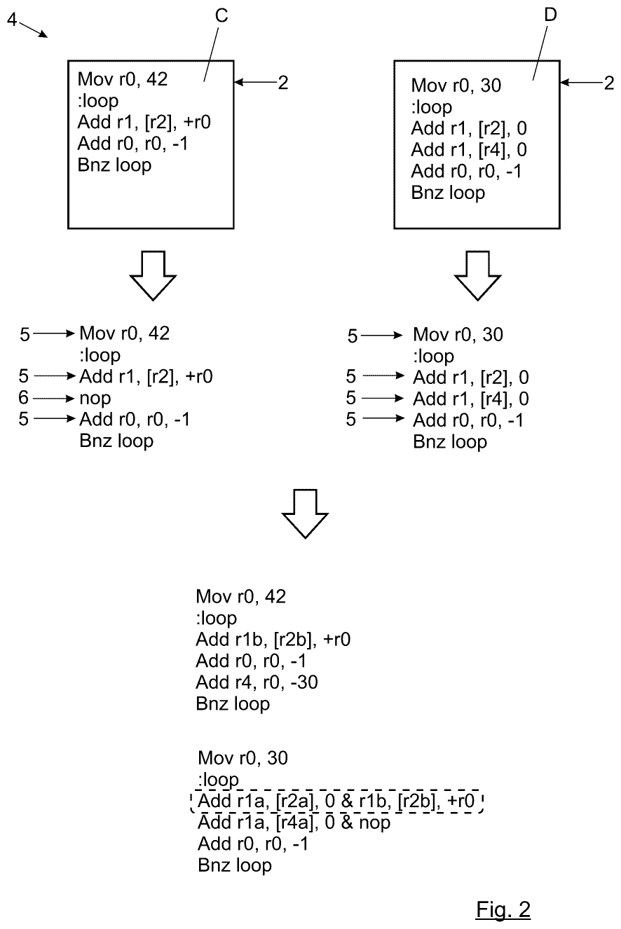

A method according to the invention serves to further increase the computational efficiency, which method enables the instructions 5 contained in the individual function blocks 2, shown in FIG. 2 in more detail, to be distributed across the processor in such a way that parts of a single task 1.1 can likewise be parallelized. The method according to the invention provides in this case that instructions 5 of the same type from function blocks 2 that can be executed in parallel are assigned to the same execution unit of the processor in accordance with single instruction, multiple data (SIMD). Therefore, the same instruction is applied to each of the different register areas of the same register in one computing cycle. “Same type” in this context therefore means the same type of instruction, i.e., that the lines of code to be parallelized all comprise the “add” command for example, which is a prerequisite for SIMD.

The method according to the invention provides that a corresponding compiler analyzes the data flow graph 3 shown in FIG. 1 and in the process ascertains the execution sequence of the respective function blocks 2. Function blocks 2 can be executed in parallel if there are no dependencies between the data exchanged via the input interfaces 2.E and output interfaces 2.A. This is the case in FIG. 1, for example, for the function blocks C and D and for the function blocks C and B. Furthermore, the function blocks A and H can also be parallelized. A parallelization for the function blocks E and F and for the task 1.2 for the function blocks M, N, O and Q is not possible due to the dependencies.

It is assumed hereinbelow that the function blocks C and D can be executed in parallel, these then forming a group 4, shown in FIG. 2, of function blocks 2 that can be executed in parallel. Depending on the complexity of the program code, such a group 4 could also contain three, four, or even more function blocks 2 that can be executed in parallel.

FIG. 2 shows the program code parts comprised by the function blocks C and D abstracted as pseudocode. Depending on the design of the information technology system and the problem to be worked through, in general any conceivable programming language can be used to implement the method according to the invention.

The command “Mov” describes moving an item of data from one register to another or from a memory to a register. Accordingly, the number 42 or 30, respectively, is assigned to the register r0.

“: Loop” describes the start of a loop and “Bnz loop” describes the end of a loop, with the premise being that r0=0 has been achieved.

The commands “Mov” and “Add” are instructions 5 to be executed by the processor of the information technology system. Instead of an addition, a multiplication or the like could also be requested. The command “Add r1, [r2], +r0” describes, for example, that the register r1 is assigned the sum of the content of the register r2 plus the value of r0. The loop shown in the function block C counts backwards from 42 to 0. The counting backwards is implemented in this case by the line of code “Add r0, r0, −1”.

The two lines of code “Add r1, [r2], +r0” from function block C and “Add r1, [r2], 0” of function block D correspond to the same instruction 5 for the processor and access the same register areas. Thus, they are suitable for the inventive assignment of the instructions 5 to the same execution unit of the processor of the information technology system in accordance with single instruction, multiple data as per the method according to the invention.

However, the loops contained in the function blocks C and D have a different number of iterations and a different number of instructions 5. To account for this fact, a so-called placeholder instruction 6 is firstly inserted into the function block C. The function blocks C and D then have the same number of instructions 5. By way of example, the designation “nop” is used as a placeholder instruction 6 and has the effect that the processor does not carry out a computing operation when reading the placeholder instruction 6.

Since the number of iterations of the loops of the function blocks C and D differs, program code parts of the function block C are first of all executed sequentially on the processor, followed by a parallel execution of the program code parts of the function blocks C and D. For instance, the loop of the function block C has 42 iterations and the loop of the function block D has 30 iterations. Therefore, the loop of the function block C is firstly executed sequentially 12 times before the program code of the function blocks C and D is then executed together 30 times on the same execution unit of the processor. Depending on the configuration of the program code and the underlying programming language, parallel execution could also take place first, followed by sequential execution.

The program code “Add r1a, [r2a], 0 & r1b, [r2b], +r0” characterized in FIG. 2 by a dashed box describes the part of the parallelized program code that leads to the actual gain in computing efficiency. In addition, the part “Add r0, r0, −1” needs to be executed less often, namely 12 times in the sequential loop and 30 times in the parallelized loop (i.e. in total 42 times), instead of 42 times sequentially and 30 times sequentially (i.e. in total 72 times) according to the prior art.

The register r1 and the register r2 are each divided into a register area a and a register area b. The program code therefore provides that the register areas b of the first and second register are accessed according to the function block C and that the register areas a of the first and second register are accessed according to the program code of the function block D.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-6. (canceled)

7. A method for operating an information technology system to complete at least one task, the method comprising:
dividing, by a compiler in a compiling operation, program code usable by a processor into at least two function blocks;
arranging, by the compiler, the at least two function block in a data flow graph;
analyzing, by the compiler, the data flow graph to determine an execution sequence in which the processor will execute respective ones of the at least two function blocks;
determining, by the compiler, function blocks of the at least two function blocks that can be executed in parallel by the processor when completing the at least one task;
checking, by the compiler, for each group of the function blocks of the at least two function blocks that can be executed in parallel, whether program code part of the at least two function blocks require a same instruction to be executed by the processor; and
assigning, by the compiler, the program code parts in accordance with single instruction, multiple data to a same execution unit of the processor for simultaneous completion.

8. The method of claim 7, wherein the compiler determines a number of instructions to be completed by the processor for each of the function blocks of the at least two function blocks that can be executed in parallel and, for those function blocks containing fewer instructions than a function block with a maximum number of instructions of a respective group, the compiler installs placeholder instructions in the respective function blocks for the respective group of function blocks that can be executed in parallel, so that all function blocks of a respective group contain a same number of instructions.

9. The method of claim 7, wherein when the program code parts contained by the function blocks of a group of function blocks of the at least two function blocks that can be executed in parallel comprise loops:
the compiler determines a respective number of iterations of the loops;
the compiler checks whether the loops of the function blocks containing the program code parts assignable to the same execution unit of the processor in accordance with single instruction, multiple data, comprise a different number of iterations; and
ensuring, by the compiler when the loops comprise a different number of iterations, that respective program code parts of the function blocks are completed simultaneously by the same execution unit of the processor in accordance with ae lowest number of iterations and those program code parts of the function blocks with a higher number of iterations are completed sequentially by the processor in accordance with remaining iterations.

10. The method of claim 7, wherein the processor is a multi-threading-capable processor, and wherein at least two different tasks are completed in parallel on at least two different execution units of the processor.

11. An information technology system comprising:
a device configured to execute a compiler so that the compiler
divides, in a compiling operation, program code usable by a processor into at least two function blocks;
arranges the at least two function block in a data flow graph;
analyzes the data flow graph to determine an execution sequence in which the processor will execute respective ones of the at least two function blocks;
determines function blocks of the at least two function blocks that can be executed in parallel by the processor when completing at least one task;
checks for each group of the function blocks of the at least two function blocks that can be executed in parallel, whether program code part of the at least two function blocks require a same instruction to be executed by the processor; and
assigns the program code parts in accordance with single instruction, multiple data to a same execution unit of the processor for simultaneous completion.

12. A vehicle comprising:
an information technology system, which comprises a device configured to execute a compiler so that the compiler
divides, in a compiling operation, program code usable by a processor into at least two function blocks;
arranges the at least two function block in a data flow graph;
analyzes the data flow graph to determine an execution sequence in which the processor will execute respective ones of the at least two function blocks;
determines function blocks of the at least two function blocks that can be executed in parallel by the processor when completing at least one task;
checks for each group of the function blocks of the at least two function blocks that can be executed in parallel, whether program code part of the at least two function blocks require a same instruction to be executed by the processor; and
assigns the program code parts in accordance with single instruction, multiple data to a same execution unit of the processor for simultaneous completion.
